(19) United States
(12) Patent Application Publication
(10) Pub. No.: US 2019/0172027 A1
(43) Pub. Date: Jun. 6, 2019

(54) PAYMENT FACILITATION SYSTEM FOR FACILITATING PAYMENT FOR A TRANSACTION

(71) Applicant: Mastercard International Incorporated, Purchase, NY (US)

(72) Inventors: Ankur Arora, New Delhi (IN); Shreya Mittal, New Delhi (IN); Manish Kumar, Gurgaon (IN)

(73) Assignee: Mastercard International Incorporated, Purchase, NY (US)

(21) Appl. No.: 16/193,124

(22) Filed: Nov. 16, 2018

(30) Foreign Application Priority Data
Dec. 4, 2017 (SG) 10201710037T

(51) Int. Cl. G06Q 20/08; G06Q 20/10; G06Q 50/00; G06Q 20/32; G06Q 20/20; G06Q 20/38

(52) U.S. Cl. CPC G06Q 20/085; G06Q 20/102; G06Q 20/388; G06Q 20/325; G06Q 20/204; G06Q 50/01

(57) ABSTRACT

A payment facilitation system for facilitating payment for a transaction, the system comprising one or more processors in communication with non-transitory data storage medium having instructions stored thereon which, when executed by the processor or processors, configure the system to perform the steps of: receiving a check-in notification from a social media system, the notification including customer identification data for one or more customers and merchant identification data; identifying a merchant terminal, the merchant terminal being a merchant terminal of a merchant associated with the merchant identification data; sending an enabled payment notification to the merchant terminal, the enabled payment notification comprising a group identifier associated with the one or more customers; receiving an invoice notification from the merchant terminal, the invoice notification comprising transaction data for the transaction and the group identifier; sending the transaction data to one or more customer devices, each customer device being associated with a respective one of the one or more customers, based on the customer identification data; receiving confirmation to process the transaction, from one of the one or more customer devices; and processing the transaction in response to receiving the confirmation to process the transaction.

### CROSS REFERENCE TO RELATED APPLICATIONS

This application claims priority to Singaporean Application Serial No. 10201710037T, filed Dec. 4, 2017, which is incorporated herein by reference in its entirety.

### FIELD OF THE INVENTION

The present invention relates to a payment facilitation system, payment facilitation method and payment facilitation network for facilitating payment for a transaction.

### BACKGROUND

Electronic payment systems have evolved from using credit and debit cards to facilitating digital payments such as those using digital wallets. However, payments are still made in a typical manner, for example, a customer would approach a merchant or his or her employee to affect a payment. Although self-check out point-of-sales (POS) systems are slowly being introduced in supermarkets, most other point-of-sales systems still require operation by the merchant or his or her employee to affect a payment.

For example, when a group of customers eat at a restaurant, they may each order a number of items of varying values. At the end of the meal, the merchant presents a single bill with a total amount to be paid. Often, one person pays for the entire bill and gets reimbursed by the other members of the group as some merchants do not allow customers to split bills.

For a merchant, processing split bills involves more employee time than processing a single bill. For example, in a typical 4-party payment transaction, the total payment transaction time may be a few minutes. As the number of customers and bill splits increases, so does the amount of employee time taken to process those bills. This may amount to a large amount of wasted time and resources in the form of employee wages for the merchant.

At tourist attractions such as the Eiffel Tower in Paris, a visitor would typically have to queue to purchase a ticket and then queue to enter the attraction. These queues are often very long and time-consuming due to the huge number of visitors to the attraction. Tourists may be deterred by the queues and decide not to visit as they are often pressed for time.

The difficulties described above are because traditional electronic payment systems typically require a merchant or his or her employee to effect the transaction, coupled with the fact that these transactions take some time to process.

It is generally desirable to overcome or ameliorate one or more of the above described difficulties, or to at least provide a useful alternative.

### SUMMARY

In accordance with embodiments of the present disclosure, there is provided a payment facilitation system for facilitating payment for a transaction, the system comprising one or more processors in communication with non-transitory data storage medium having instructions stored thereon which, when executed by the processor or processors, configure the system to perform the steps of:
(a) receiving a check-in notification from a social media system, the notification including:
   (i) customer identification data for one or more customers; and
   (ii) merchant identification data;
(b) identifying a merchant terminal, the merchant terminal being a merchant terminal of a merchant associated with the merchant identification data;
(c) sending an enabled payment notification to the merchant terminal, the enabled payment notification comprising a group identifier associated with the one or more customers;
(d) receiving an invoice notification from the merchant terminal, the invoice notification comprising:
   (i) transaction data for the transaction; and
   (ii) the group identifier;
(e) sending the transaction data to one or more customer devices, each customer device being associated with a respective one of the one or more customers, based on the customer identification data;
(f) receiving confirmation to process the transaction, from one of the one or more customer devices; and
(g) processing the transaction in response to receiving the confirmation to process the transaction.

In accordance with some embodiments, there is also provided a payment facilitation method for facilitating payment for a transaction, performed by one or more processors in communication with non-transitory data storage medium having instructions stored thereon which, when executed by the processor or processors, performs the steps of:
(a) receiving a check-in notification from a social media system, the notification including:
   (i) customer identification data for one or more customers; and
   (ii) merchant identification data;
(b) identifying a merchant terminal, the merchant terminal being a merchant terminal of a merchant associated with the merchant identification data;
(c) sending an enabled payment notification to the merchant terminal, the enabled payment notification comprising a group identifier associated with the one or more customers;
(d) receiving an invoice notification from the merchant terminal, the invoice notification comprising:
   (i) transaction data for the transaction; and
   (ii) the group identifier;
(e) sending the transaction data to one or more customer devices, each customer device being associated with a respective one of the one or more customers, based on the customer identification data;
(f) receiving confirmation to process the transaction, from one of the one or more customer devices; and
(g) processing the transaction in response to receiving the confirmation to process the transaction.

In accordance with some embodiments, there is also provided a payment facilitation network for facilitating payment a transaction, the payment facilitation network comprising:

a payment facilitation system;

a social media system;

a merchant terminal; and

one or more customer devices,

the payment facilitation system, social media system, merchant terminal and one or more customer devices communicating to perform the steps of:
(i) receiving, at the payment facilitation system, a check-in notification sent from the social media system, the notification including:
   (A) customer identification data for one or more customers; and
   (B) merchant identification data;
(ii) identifying, at the payment facilitation system, the merchant terminal, the merchant terminal being a merchant terminal of a merchant associated with the merchant identification data;
(iii) sending an enabled payment notification, from the payment facilitation system to the merchant terminal, the enabled payment notification comprising a group identifier associated with the one or more customers;
(iv) receiving, at the payment facilitation system, an invoice notification sent from the merchant terminal, the invoice notification comprising:
   (A) transaction data for the transaction; and
   (B) the group identifier;
(v) sending the transaction data, from the payment facilitation system to the one or more customer devices, each customer device being associated with a respective one of the one or more customers, based on the customer identification data;
(vi) receiving, at the payment facilitation system, confirmation to process the transaction, from one of the one or more customer devices; and
(vii) processing the transaction, at the payment facilitation system, in response to receiving the confirmation to process the transaction.

### BRIEF DESCRIPTION OF THE DRAWINGS

Embodiments of the present disclosure are hereafter described, by way of non-limiting example only, with reference to the accompanying drawings in which:

FIG. 1 is a flowchart diagram showing the interoperation of the components of embodiments of the system for facilitating payment;

FIG. 1a is a flowchart diagram showing a payment facilitation method for facilitating payment for a transaction;

FIG. 2 is a schematic diagram of a payment facilitation network for facilitating payment for one or more transactions;

FIG. 3 is a flowchart diagram payment facilitation method for facilitating payment for a transaction for one or more customers;

FIG. 4 is a flowchart diagram merchant registration method for registering a merchant;

FIG. 5 is a block diagram of an example mobile computing device of the system shown in FIG. 1; and

FIG. 6 is a schematic diagram showing components of an example computing device of the system shown in FIG. 1.

### DETAILED DESCRIPTION OF EMBODIMENTS OF THE INVENTION

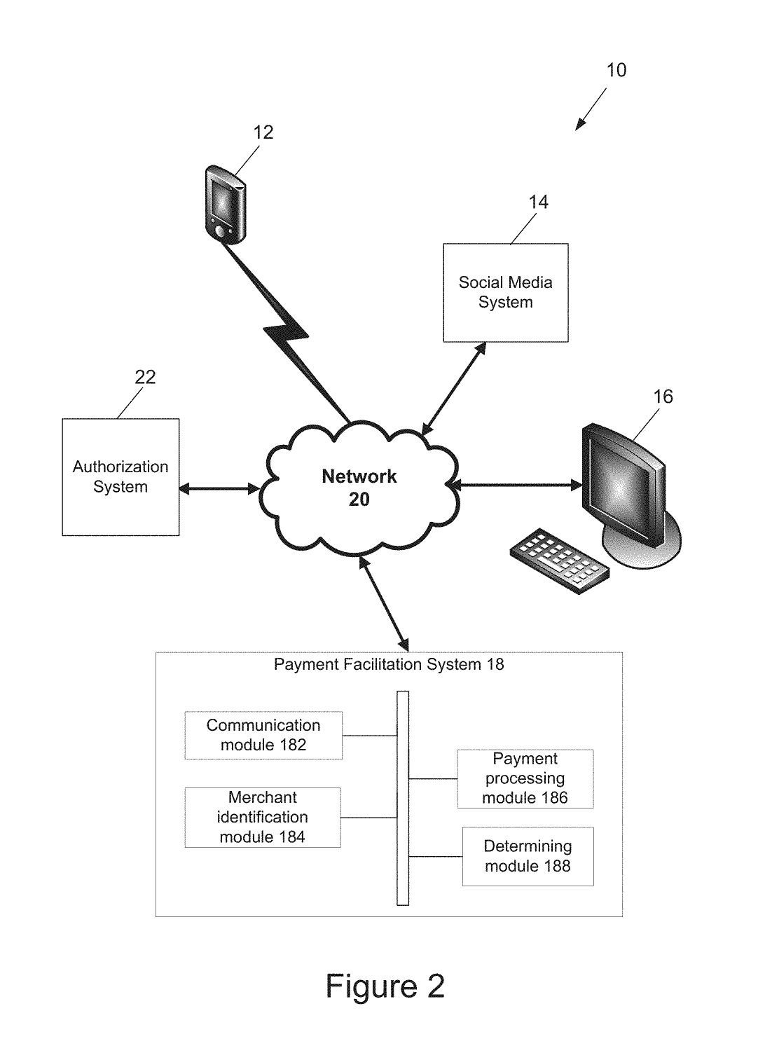

The example payment facilitation network 10 shown in FIG. 2 allows payments to be facilitated for a transaction on receipt of a customer's check-in notification on a social media system. The payment facilitation network 10 comprises the following:
(a) mobile computing device 12 of a customer;
(b) social media system 14;
(c) merchant's terminal 16;
(d) payment facilitation system 18; and
(e) authorization system 22.

The components of payment facilitation network 10 are in communication with each other via a network 20. The network 20 may include the Internet, telecommunications networks and/or local area networks.

The payment facilitation network 10 makes payment transactions simpler, faster and more convenient. The payment facilitation network 10 provides a way of using social media to identify parties of a transaction and facilitates the passing of an invoice between parties. Advantageously, if there is a plurality of customers, each customer can separately pay for their portions of a total bill.

### Payment Facilitation Process

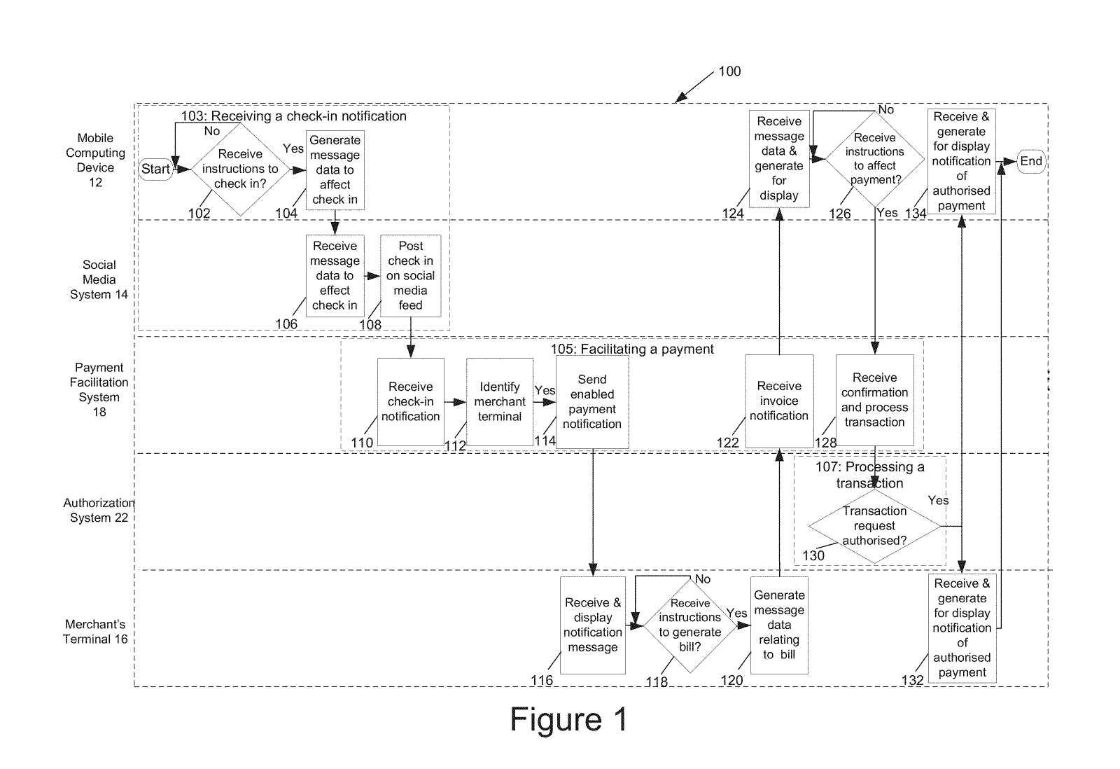

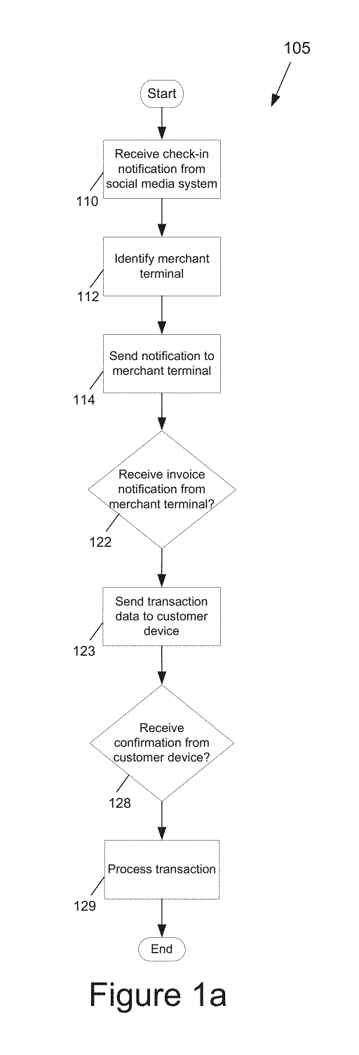

FIG. 1 shows a process 100 for facilitating payment for a transaction, performed using a payment facilitation network such as payment facilitation network 10 of FIG. 2. FIG. 1a shows a step 105 for facilitating payment for a transaction, performed using a payment facilitation system 18 of FIG. 2.

The process 100 enables a customer, or group of two or more customers, to ‘check-in’ at the premises of a merchant and pay for purchases made with that merchant, through their mobile computing device 12. In embodiments described below, a customer “checks-in” on a social media application, e.g. an App 518 running on their mobile computing device 12—to indicate they are at a merchant's premises. A check-in on a social media application involves the customer notifying the merchant, via a social media system (see reference 14 in FIG. 1) and payment facilitation system (see reference 18 in FIG. 1), that they have arrived at a certain location—e.g. the merchant's premises. The process for checking-in is discussed further with reference to FIG. 1.

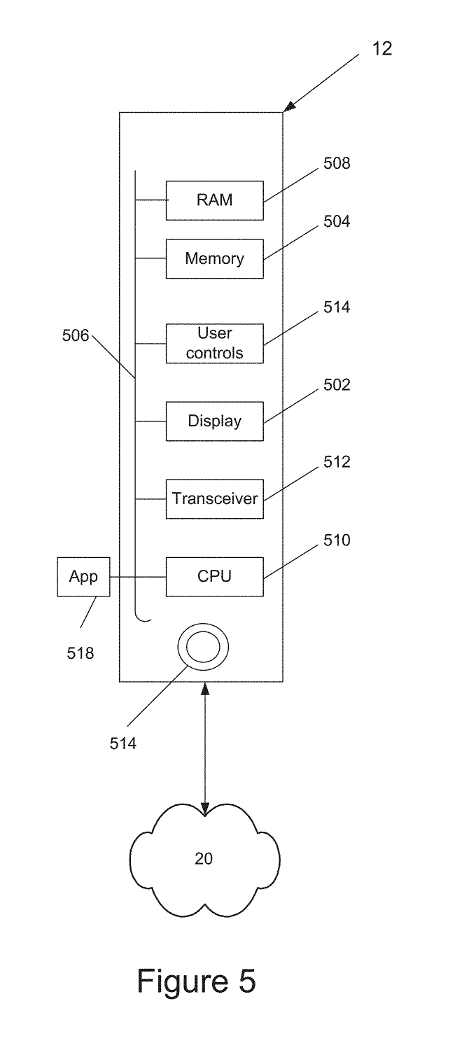

The social media application can be a standalone application or can be accessed via a web browser. The merchant receives a notification on the social media application running on the merchant's terminal 16 that a customer has “checked-in”. At an appropriate time, for example, if the merchant's premise is a restaurant this may be after the customer has finished their meal, the merchant sends a bill or invoice from the merchant's terminal 16 to the mobile computing device 12 of the customer. The customer then has the option of paying for his or her purchase via the mobile computing device 12, i.e. “check-out”. Check-out is generally used to describe the process affected by a user to purchase goods or services, whether online or at a physical retail store. As used herein, to “check-out” is used specifically to refer to a user paying for his or her purchase using a mobile computing device 12, or similar. For example, a check-out may be affected by an app (e.g. App 518 of FIG. 5) running on the mobile computing device 12—the app may be a social media app, a digital wallet app—for example MasterPass or ApplePay—or other similar app running on mobile computing device 12.

If the customer selects the option to “check-out” using their mobile computing device 12, the payment facilitation system 18 receives data from the mobile computing device 12 of the customer. The payment facilitation system 18 then facilitates the payment transaction by communicating with the authorization system 22 which determines if the transaction is authorized. If the transaction is authorized, the merchant and customer receive a notification on the merchant's terminal 16 and mobile computing device 12 of the customer respectively.

In another embodiment involving multiple customers, a first customer may check-in and:
associate the remaining customers to the check-in post at the same time to indicate that they are in the same group, for example at the same table at a restaurant, or
the remaining customers, upon seeing the first customer's check-in post on their social media feed, may check-in by associating themselves with the first customer—e.g. by indicating that they are sitting at the same table or by associating their social media account with that of the first customer (e.g. by selecting an option to edit the first customer's check-in post by adding themselves to the post on Facebook®).

In these cases, the option to “check-out” presented to the customers includes a list of purchases that each customer can select to indicate that they would like to pay for those items only. Alternatively, a split bill option may be selected by the customers allowing the customers to pay for a portion of the bill, for example 20% of the bill per customer for a table of five.

Embodiments of the invention allow customers to reduce the amount of time required to pay for their purchases. For example, for large groups of customers who want to split their bill, the time it takes for a merchant, or his or her employee, to complete processing of multiple payments for a single invoice, that has been split, can be significant. Similarly, the merchant can reduce the amount of time required for employees to perform bill or invoice settlements thereby freeing the employees up to perform other tasks or duties.

The process 100 broadly comprises:

Step 103: receiving a check-in notification;

Step 105: facilitating a payment for a transaction; and

Step 107: processing a transaction.

These steps are described in further detail below.

In an embodiment, to affect Step 102 a customer enters a merchant's premises. The premises may be a retail shop, restaurant, museum or any tourist attraction. In another embodiment, one or more customers may be at a location other than the merchant's premises. The group may, for example, decide to buy or order something from the merchant—e.g. food to be delivered—using the payment facilitation system 18 to remotely affect the payment and split that payment between the one or more customers using process 100. In this case, the one or more customers do not need to be physically at the merchant's premises.

The customer then launches a Social Media App 518 on the mobile computing device 12 of the customer. The Social Media App 518 may be any one of a number of applications such as Facebook, Instagram, Twitter, Google+, Sina Weibo, Baidu Tieba.

The home page of the App 518 may have a selectable icon or text on display 502, which when selected causes the mobile computing device 12 of the customer to generate on display 502 a check-in landing page.

In some embodiments, the mobile computing device 12 of the customer has a GPS transceiver 512. The App 518 on the mobile computing device 12 is configured to detect when the customer is in the vicinity of a merchant. In some embodiments, only merchants registered with the payment facilitation system 18 (i.e. a “registered merchant”) are allowed to use the process 100 described with reference to FIG. 1. For example, registered merchants within a predetermined distance, e.g. 50 m, of the GPS coordinates of the mobile computing device 12 determined by GPS transceiver 512 may be suggested—e.g. listed on the display 502 of the mobile computing device 12. Alternatively, the customer may type in the name of the merchant and the App 518 retrieves a list of merchants with identical or similar names as that inputted by the user. The App 518 running on mobile computing device 12 generates on display the list of retrieved merchants from which the customer may select a particular merchant.

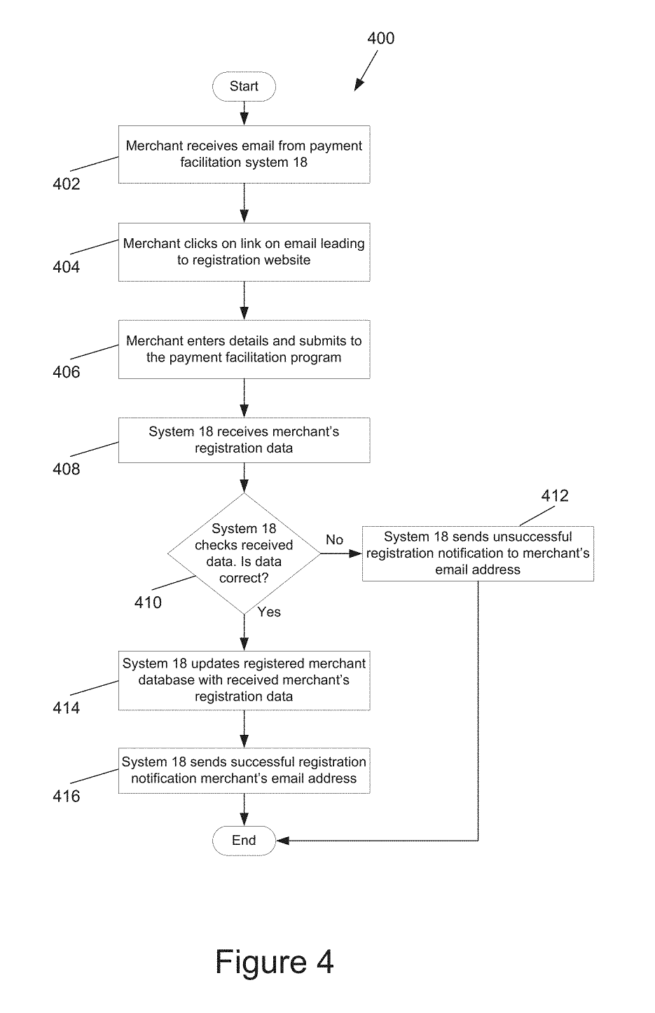

In some embodiments, prior registration with the payment facilitation system 18 to become a registered merchant is required by the merchant to indicate that the merchant would like to participate in using the payment facilitation system 18 to effect payments on behalf of the merchant for customers who have checked-in on a social media system 14 by executing App 518 on their mobile computing device 12. As particularly shown in FIG. 4, an example of a merchant registration process is described with reference to process 400. For example, the registration process may include the payment facilitation system 18 requesting the merchant to “opt-in” to the program. This may be done by means of sending an email to a merchant with a link attached which when clicked allows a merchant to access a website to register as a registered merchant. At step 402, the merchant receives an email and views the contents of the email, on a mobile computing device 12 or computer system 600 for example, from the payment facilitation system 18. The email may include details of the program and a clickable link which a merchant can click on if they were interested in registering as a registered merchant. At step 404, the merchant clicks on the link on the email which may lead the merchant to a registration website hosted by the payment facilitation system 18, for example.

At step 406, the merchant enters in merchant registration data by typing into a fillable form on the registration website information such as the business name, address and type of business, for example. The merchant then submits the information on the website to the payment facilitation program. At step 408, the payment facilitation system 18 receives the merchant registration data. At step 410, the payment facilitation system 18 checks if the data appears to be correctly entered. For example, the business name is verified if it is indeed a legitimate business by looking up a business registry or the registered address of the business is checked against the business registry. If the data appears incorrect, the payment facilitation system 18 executes step 412 which sends an unsuccessful registration notification to the merchant, for example by sending an email to the merchant's email address. If the data appears correct, the payment facilitation system 18 performs step 414 which updates the registered merchant's database to include a new registered merchant with the received merchant registration data. Upon successful updating, the payment facilitation system 18 performs step 416 which sends a successful registration notification to the merchant, for example by sending an email to the merchant's email address. This concludes process 400.

The App 518 running on the mobile computing device 12 may detect when the customer is in the vicinity of a registered merchant by comparing GPS coordinates determined by the GPS transceiver 512 in the mobile computing device 12 of the customer against a list of known locations of registered merchants. The list of registered merchants may be stored on a database 616 that is accessed by the App 518, e.g. in cloud-based storage system hosted by the payment facilitation system 18. Alternatively, the App 518 may retrieve the list of registered merchants from database 616, store the list in memory 504 of the mobile computing device 12 and periodically, e.g. every week, update the list by comparing the list on database 616 against the list stored in memory 504 and implementing any changes in the list, if any.

If the GPS coordinate of the GPS transceiver 512 is within a certain range of a location of a registered merchant, the App 518 generates a notification on display 502 and displays an option for the customer to affect a check-in (e.g. by touching a “check-in” virtual button on a touch screen display of the mobile computing device 12) without the customer having to launch the App 518. In instances where multiple registered merchants are near the identified GPS coordinates of the mobile computing device 12, a list of those merchants may be displayed to the customer on the mobile computing device 12, for individual selection by the customer—e.g. the mobile computing device 12 may register a touch gesture on a touch screen display, the gesture resulting in selection of a merchant name from the list. For example, registered merchants within a predetermined distance, e.g. 50 m, of the GPS coordinates of the mobile computing device 12 determined by GPS transceiver 512 may be suggested—e.g. listed on the display 502 of the mobile computing device 12. Alternatively, the customer may type in the name of the merchant and the mobile computing device 12 retrieves a list of merchants with identical or similar names as that inputted by the user. The App 518 running on mobile computing device 12 generates on display the list of retrieved merchants from which the customer may select a particular merchant. If the customer does not want to affect a check-in, they can opt to ignore or dismiss the notification.

After selection of the check-in option is affected, whether this is affected after the user was prompted by the App 518 based on the GPS transceiver or by accessing the App 518 and clicking on the “check-in” option on the landing page, the mobile computing device 12 causes the App 518 to generate message data to affect check-in (step 104). For example, the following selectable text boxes are generated for selection on display 502:
(a) “Where are you?”; and
(b) “Who are you with?”.

If the customer has already chosen the merchant based on its GPS location, the merchant chosen merchant is displayed after the “Where are you?” text box and allows the customer to change their selection by selecting on the text box. Preferably, after the “Where are you?” text box is selected, the App 518 generates on display 502 suggestions of one or more merchant locations based on the proximity of the customer to the one or more merchants. For example, registered merchants within a predetermined distance, e.g. 50 m, of the GPS coordinates of the mobile computing device 12 determined by a transceiver component such as GPS transceiver 512 may be suggested—e.g. listed on the display 502 of the mobile computing device 12. Alternatively, the customer may type in the name of the merchant and the App 518 retrieves a list of merchants with identical or similar names as that inputted by the user. The App 518 generates on display the list of retrieved merchants from which the customer may select a particular merchant.

Advantageously, after selecting the “Who are you with?” selection for tagging one or more other customers that the current customer is with, the App 518 generates on display 502 suggestions of one or more customers that the customer can select. For example, the suggestion may be based on a “favorites” list which may be people who the customer often interacts with on the social media system. Additionally, if a customer of the one or more customers is not registered on the social media system, their name may be manually added to the group—e.g. their name may be typed into an “additional customer” field on the display 502 of the mobile computing device 12. If the customer is alone, he or she may just check-in by selecting the merchant's location without tagging anyone else.

After receiving the abovementioned user input—e.g. the merchant location and any other selected customers—the App 518 generates check-in details on display 502, including the abovementioned user input, for check-in confirmation. After confirmation, the merchant location may be posted on the social media feed of each customer registered with the social media system 14. At step 102, the mobile computing device 12 of the customer receives confirmation to affect check-in including the abovementioned check-in details. At step 104, the mobile computing device 12 of the customer generates a check-in notification and sends it to the social media system 14. Preferably, the check-in notification includes the following:
(a) customer identification data for one or more customers; and
(b) merchant identification data.

The customer identification data may include one or more of the following:
(a) name of one or more customers;
(b) image associated with one or more customers; and
(c) identification number associated with one or more customers.

The merchant identification data may be one or more of the following:
(a) name of merchant;
(b) location of merchant; and
(c) identification number associated with merchant.

At step 106, the social media system 14 receives the check-in notification from the mobile computing device 12 of the customer. At step 108, the social media system 14 generates and sends a check-in post to be posted on the customer's social media feed according to the customer's social media privacy settings—privacy settings and their operation will be understood by the skilled person. If the customer selected one or more other customers within the check-in post, the social media system 14 may also send the check-in post to be posted on the social media feed of each other customer according to their respective social media privacy settings. In some embodiments, a confirmation of the check-in is required by the other customers before the post is allowed on their social media feed.

After step 108, the social media system 14 generates and sends a check-in notification to a payment facilitation system 18. For example, the social media system 14 may matches the name of the merchant in the merchant identification data to the name of a merchant in a list of registered merchants and, if there is a match, send a check-in notification to a payment facilitation system 18 if the social media system 14. The payment facilitation system 18 may host the list of registered merchants on a database, e.g. a cloud-based storage system, which is accessible by the social media system 14. Alternatively, the social media system 14 may retrieve and store the list of registered merchants from database of payment facilitation system 18, and routinely update the list e.g. at the end of each day or week, by comparing the list stored on the social media system 14 against the list stored on a database of payment facilitation system 18. At step 110, the payment facilitation system 18 receives the check-in notification, using the communication module 182 which may include a transceiver, including the customer identification data and the merchant identification data.

At step 112, the payment facilitation system 18 determines, based on the merchant identification data and using the determining module 188 which may include one or more processors for affecting step 112, if the merchant associated with the merchant identification data is registered to be part of the payment facilitation system 18. This may be achieved by identifying the merchant, using a merchant identification module 184, from a list of merchants stored in a non-transitory storage medium, based on the merchant identification data. Preferably, merchant information includes a merchant terminal ID for communicating with the merchant. This will enable the payment facilitation system 18 to directly identify the merchant's terminal 16 to which it should send and enable payment notification according to step 114.

At step 114, if the merchant is registered with the payment facilitation system 18, the payment facilitation system 18 generates a group identifier as a reference for the one or more customers—the group identifier, being a, preferably unique, number associated with the transaction, allows the payment facilitation system 18 and the merchant's terminal 16 to identify the transaction. The payment facilitation system 18 then sends an enabled payment notification (including the group identifier) to the merchant's terminal 16 associated with the merchant using the communication module 182. An enabled payment notification indicates to the merchant that the one or more customers who have just checked in are able to pay invoices, issued by the merchant, through the payment facilitation system 18.

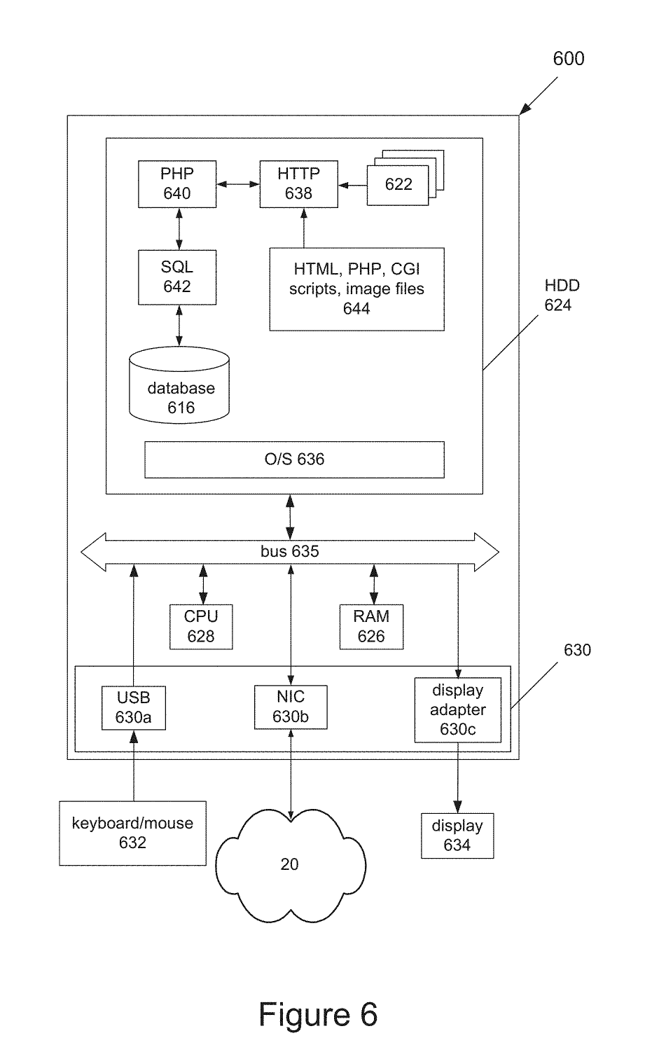

The merchant's terminal 16 associated with the merchant may be one of the following:
(a) a computing device, for example computer system 600 as particularly shown in FIG. 6;
(b) a mobile computing device, for example mobile computing device 12 as particularly shown in FIG. 5; and
(c) a point-of-sale (POS) system.

At step 116, the merchant's terminal 16 receives the enabled payment notification and generates the enabled payment notification on a display of the merchant's terminal 16. The merchant is thus alerted to the fact that one or more customers have just checked in on social media and can pay through the social media system 14. The merchant can then decide to engage with the one or more customers by offering an option to the one or more customers to pay using the mobile computing device 12 associated with the one or more customers—e.g. via the social media system 14.

The merchant may be able to identify the customer from the customer identification data. This may be by way of a profile picture, phone number, social media profile link etc. Alternatively, the merchant may have to check with the customer if the customer had just checked in with the customer identification data. Identifying the customer will allow the merchant to direct an invoice to the payment facilitation system 18 with the correct group identifier.

In another embodiment, the merchant stores a list of customers who have checked-in using social media. A customer who wishes to pay using the payment facilitation system 18 and social media system 14 may request that the merchant generate the bill via an app such as a social media app 518 running on mobile computing device 12. The merchant may confirm the customer is present on the list of customers checked-in with the merchant—this may be achieved by comparing profile pictures of checked-in customers against the appearance of the customer in question, by cross-referencing a social media profile link supplied by the person to the profile links of checked-in customers etc. Once the identity of the customer is confirmed, the customer may pay using the processes described with reference to FIG. 1. Alternatively, the merchant may post the bill to the customer's social media feed from which the customer can pay, for example, using a credit or debit card registered for use on the relevant social media system 14.

In another embodiment, a tag, code or message (e.g. Quick-Response (QR) code, barcode, table number etc.) may be provided on each table. That tag can be scanned by the mobile computing device 12 of the customer (e.g. smartphone) to affect check-in. Once a tag, code or message is scanned by the mobile computing device 12 of the customer, the social media system 14 uses the tag, code or message to identify the merchant. The social media system 14 may then open a merchant page (i.e. a social media feed of the merchant) on the social media system 14, to facilitate check-in via the mobile computing device 12 of the customer.

The tag, code or message may also comprise metadata for identifying a particular branch or outlet for the merchant where, for example, a single social media page is provided for multiple branches or outlets of the same merchant. That metadata may further include the relevant table number and/or other details.

The payment facilitation system 18 may supply the relevant tag to the merchant's terminal 16. The payment facilitation system 18 may further supply the group identifier to the merchant's terminal 16, or the tag may be used as the group identifier.

At step 118, the merchant's terminal 16 receives instructions to generate the invoice. The instructions may be generated by one or more of the customers scanning the abovementioned tag, code or message, or by selecting a check out button on their corresponding mobile computing device 12. Scanning the tag, code or message, or selecting the checkout button, forwards an invoice request notification to the payment facilitation system 18, which subsequently forwards the invoice request notification to the merchant's terminal 16.

In some embodiments the merchant may select, on the merchant's terminal 16, which orders correspond with the group identifier. Where the merchant's terminal 16 associates the group identifier with, for example, a particular table or reservation number at the merchant's premises, receipt of the invoice request notification from the payment facilitation system 18 may result in the merchant's terminal 16 automatically generating an invoice for the item(s) to be purchased by the customer(s) based on the particular table or reservation number. Otherwise, the merchant may input the transaction information into the merchant's terminal 16 using an input device such as a keyboard, and then issue the invoice to the payment facilitation system 18.

At step 120, the merchant's terminal 16 generates and sends an invoice notification to the payment facilitation system 18. The invoice notification may include:
(a) transaction data for the transaction; and
(b) the group identifier.

The transaction data may further comprise:
(a) a total amount associated with the invoice;
(b) an itemized list associated with the invoice; and
(c) an amount associated with each item in the itemized list.

At step 122, the payment facilitation system 18, using the communication module 182, receives the invoice notification from the merchant's terminal 16 and at step 123 forwards the transaction data to the mobile computing device 12 of each customer, based on the customer identification data.

At step 124, the one or more mobile computing devices 12 of the customer(s) receive the transaction data from the payment facilitation system 18 and display the transaction data on display 502. Preferably, the mobile computing device 12 of the customer generates on display 502:
(a) a total amount associated with the invoice;
(b) an itemized list associated with the invoice; and
(c) an amount associated with each item in the itemized list.

Where multiple customers split an invoice, the information displayed on display 502 of each mobile computing device 12 may be the information relevant to the charges payable by the customer with whom the mobile computing device 12 is associated.

The one or more customers can then decide if they would like to pay for the transaction using the payment facilitation system 18. If they do not want to, they can just ignore the transaction data and pay through pre-existing channels—e.g. standard credit card payment.

If the customer decides to use the payment facilitation system 18 to affect a transaction, the customer makes a selection on the mobile computing device 12. At step 126, the mobile computing device 12 of the customer receives instruction to affect a payment transaction. That instruction may comprise an instruction to pay the full amount of the invoice—i.e. a total amount associated with invoice—or may comprise an instruction to pay an amount different from the total amount associated with the invoice—e.g. the amount of the customer's split of a split invoice. To enable a subset of the one or more customers to pay by means other than the payment facilitation system 18, the payment facilitation system 18 may send to the merchant's terminal 16 of notification advising the merchant's terminal 16 of the outstanding balance remaining in order to completely settle the invoice. Similarly, the payment facilitation system 18 may, upon receipt of an instruction from one of the customers, send to any other customers a notification comprising revised transaction data, the revised transaction data having a total invoice amount that is reduced by the amount paid by said one customer.

Advantageously, the mobile computing device 12 of the customer may generate on display 502 payment selection(s) to enable payment for the total amount associated with the invoice or for a subset of the items listed in an itemized list of orders. After the customer makes their payment selection(s), the mobile computing device 12 sends instruction to the payment facilitation system 18 to pay in accordance with the customer's payment selection(s).

At step 128, the payment facilitation system 18 receives confirmation to process the transaction and generates a payment transaction request, using the payment processing module 186, based on the customer's transaction data. At step 129, the transaction is processed. In some embodiments, the authorization system 22 is part of the payment facilitation system 18. To this end, the payment facilitation system 18 may be hosted by any entity. If the entity hosting the payment facilitation system 18 is the issuer, the issuer can then proceed to determine if the transaction is to be authorized—this determination is known and involves, for example, checking whether an outstanding balance of an account (e.g. a credit card account) held by the customer has sufficient balance to pay for the transaction. Otherwise, the payment facilitation system 18 will forward the payment transaction request to the issuer for authorization. At step 130, if the transaction is authorized, the payment facilitation system 18 generates a notification message of authorized payment and sends the notification message to the mobile computing device 12 of the customer and the merchant's terminal 16. At steps 132 and 134, the mobile computing device 12 and merchant's terminal 16 respectively receive and generate for display notification of authorized payment.

After step 130, the payment facilitation system 18 checks if the amount associated with the authorized payment is at least equal to the total amount associated with the invoice. If so, the process 100 ends. If the amount associated with the authorized payment is less than the total amount associated with the invoice, the payment facilitation system 18 determines, using determining module 188, a remainder amount associated with the invoice—this is done by deducting the amount associated with the authorized payment from a total remainder amount associated with the invoice (i.e. the total amount associated with the invoice minus any previously authorized payments). The transaction data is then updated to include the remainder amount and to reflect the processed transaction. The communication module 182 then sends the updated transaction data to the one or more customer devices. Once another customer device of the one or more customer devices sends confirmation to process the transaction, the confirmation comprising an amount to be paid by the customer associated with the relevant customer device, communication module 182 receives that confirmation, the communication module 182 sends the confirmation to the payment processing module. The payment processing module 186 then processes the transaction. The process of determining the remainder amount and processing further transactions repeats until the total amount of authorized payment is at least equal to the total amount of the invoice.

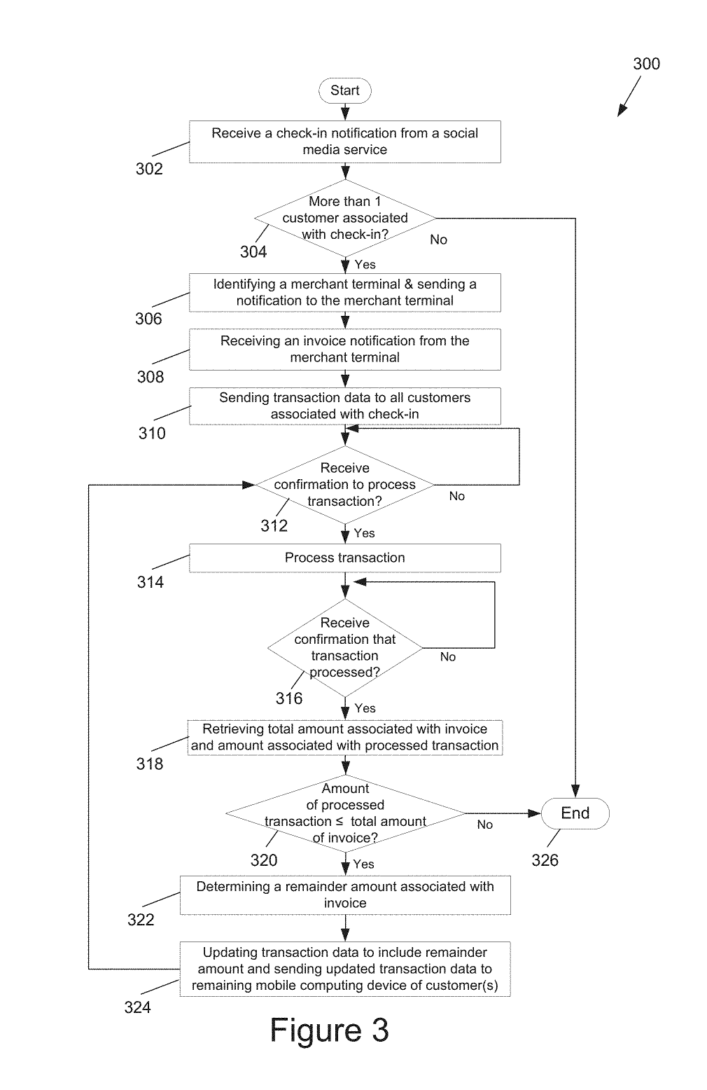

Process 300 shows another embodiment of the payment facilitation process for more than one transactions executed by the payment facilitation system 18. Similar to determining a remainder amount as previously described, process 300 is typically executed when more than one customer is associated with the invoice—for example, if a group of customers check in together at a restaurant. If so, multiple transactions may be carried out separately by each customer before the total amount associated with the invoice is completely paid up. Each customer may choose to pay for a specified amount or a proportion of the bill. If so, the payment facilitation system 18 performs process 300 as particularly shown in FIG. 3.

At step 302, the payment facilitation system 18 receives, using the communication module 182, a check-in notification from a social media system 14, the notification including:
(a) customer identification data for one or more customers; and
(b) merchant identification data;

At step 304, the payment facilitation system 18 determines if the customer identification data is for more than 1 customer. If there is only one customer, process 300 ends. If there is more than 1 customer associated with the check-in, the payment facilitation system 18 uses the merchant identification data to identify a merchant terminal of a merchant associated with the merchant identification data (step 306). The payment facilitation system 18 then sends, using communication module 182, an enabled payment notification to the merchant's terminal 16. The enabled payment notification comprises a group identifier associated with the one or more customers.

At step 308, the payment facilitation system 18 receives an invoice notification from the merchant's terminal 16. The invoice notification comprises:
(a) transaction data for the transaction; and
(b) the group identifier.

At step 310, the payment facilitation system 18 sends the transaction data to the mobile computing device 12 of each customer, each mobile computing device 12 being associated with a respective one of the one or more customers, based on the customer identification data.

At step 312, the payment facilitation system 18 receives confirmation to process the transaction, from a mobile computing device 12 of a customer. At step 314, the payment facilitation system 18 processes the transaction in response to receiving the confirmation to process the transaction at step 312.

At step 316, the payment facilitation system 18 waits until it receives confirmation that the transaction was successfully processed from the authorization system 22. After that confirmation is received, the payment facilitation system 18 retrieves the total amount associated with the invoice and an amount associated with the processed transaction, from the non-transitory data storage medium (step 318).

At step 320, the determining module 188 determines if the amount associated with the processed transaction is at least equal to the total amount associated with the invoice. If the amount associated with the processed transaction is at least equal to the total amount associated with the invoice, then process 300 ends (step 326).

At step 322, responsive to a determination that the amount associated with the transaction is less than the total amount to be paid, the determining module 188 determines a remainder amount associated with the invoice. This is done by deducting the amount associated with the processed transaction from the total amount associated with the invoice as discussed above.

At step 324, the payment facilitation system 18 updates the transaction data to include the remainder amount and to reflect the processed transaction. The payment facilitation system 18 then sends the updated transaction data to the mobile computing device 12 of the customer or to each mobile computing device of each customer in the group.

The payment facilitation system 18 then receives confirmation to process the transaction, from at least one mobile computing device 12 of the one or more customers. In other words, confirmation is received to process a further transaction. In response to receiving the confirmation to process the transaction, the payment facilitation system 18 processes the transaction using the payment processing module 186.

The payment facilitation system repeats steps 312 to 324 until the total amount of processed transactions is at least equal to the total amount of the invoice. Once the total amount of processed transactions is at least equal to the total amount of the invoice, the process ends (step 326).

In some embodiments, the customer pays the invoice, or a portion of the invoice, by using a digital wallet account. In other embodiments, the payment facilitation system 18 may have the payment details of the one or more customers required to affect a transaction. In other embodiments, the customer may have to enter his or her payment credentials such as their credit card details to affect the payment.

### Mobile Computing Device 12

FIG. 5 is a block diagram showing an example mobile computing device 12, for example one used by a customer, in which embodiments of the invention may be practiced. The mobile computing device 12 may be a smart phone, a personal data assistant (PDA), a palm-top computer, or a multimedia Internet enabled cellular telephone. For ease of description, the mobile computing device 12 is described below, by way of non-limiting example, with reference to the smartphone or a mobile phone in the form of an iPhone™ manufactured by Apple™, Inc., or one manufactured by LG™, HTC™ and Samsung™, for example.

As shown, the mobile computing device 12 comprises the following components in electronic communication via a bus 506:
(a) a display 502;
(b) non-volatile (non-transitory) memory 504;
(c) random access memory (“RAM”) 508;
(d) N processing components 510;
(e) a transceiver component 512 that comprises N transceivers; and
(f) user controls 514.

Although the components depicted in FIG. 5 represent physical components, FIG. 5 is not intended to be a hardware diagram. Thus, many of the components depicted in FIG. 5 may be realized by common constructs or distributed among additional physical components. Moreover, it is certainly contemplated that other existing and yet-to-be developed physical components and architectures may be utilized to implement the functional components described with reference to FIG. 5.

The display 502 generally operates to provide a presentation of content to a customer, and may be realized by any of a variety of displays (e.g., CRT, LCD, HDMI, micro-projector and OLED displays).

In general, the non-volatile data storage 504 (also referred to as non-volatile memory) functions to store (e.g., persistently store) data and executable code including code that is associated with the functional components of App 518 that executes some of the processes 100 set out in FIG. 1.

In some embodiments for example, the non-volatile memory 504 comprises bootloader code, modem software, operating system code, file system code, and code to facilitate the implementation of the App 518 as well as other components, known to those of ordinary skill in the art, which are not depicted nor described for simplicity.

In many implementations, the non-volatile memory 504 is realized by flash memory (e.g., NAND or ONENAND memory), but it is certainly contemplated that other memory types may be utilized as well. Although it may be possible to execute the code from the non-volatile memory 504, the executable code in the non-volatile memory 504 is typically loaded into RAM 508 and executed by one or more of the N processing components 510.

The N processing components 510 in connection with RAM 508 generally operate to execute the instructions stored in non-volatile memory 504. As one of ordinarily skill in the art will appreciate, the N processing components 510 may comprise a video processor, modem processor, DSP, graphics processing unit (GPU), and other processing components.

The transceiver component 512 comprises N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks. For example, each transceiver may also correspond to a GPS receiver for geo-location.

It should be recognized that FIG. 5 is merely an example and in one or more example embodiments, the functions described herein may be implemented in hardware, software, firmware, or any combination thereof. If implemented in software, the functions may be stored on or transmitted over as one or more instructions or code encoded on a non-volatile memory or non-transitory computer-readable medium 504. Non-transitory computer-readable medium 504 comprises both computer storage medium and communication medium including any medium that facilitates transfer of a computer program from one place to another. A storage medium may be any available medium that can be accessed by a computer.

Social Media System 14

Social media system 14 is hosted by a social media service such as Facebook, Instagram, Twitter, Google+, Sina Weibo, Baidu Tieba, and etc. Preferably, a social media host provides a social media system whereby third-party developers may create their own applications and services that share data with a social media application. For example, Facebook launched the Facebook Platform and provides a framework for developers to create applications that can interact with core Facebook features.

Social media system 14 may be embodied by a computer system such as that embodied as computer system 600 as particularly shown in FIG. 6.

### Merchant's Terminal 16

The merchant's terminal 16 may be embodied by a computer system such as that embodied as computer system 600. In another embodiment, the merchant's terminal 16 is embodied by a mobile computing device such as one described as the mobile computing device 12 of a customer.

Advantageously, the merchant's terminal 16 is in communication with the merchant's point-of-sales system. In some embodiments, the merchant's terminal 16 also provides for the point-of-sales system.

### Payment Facilitation System 18

The payment facilitation system 18 may be provided for by one of the entities from an authorization system 22 e.g. a payment network, issuer or acquirer. Alternatively, the payment facilitation system 18 may be part of the social media system 14. In yet another embodiment, the payment facilitation system 18 is part of a digital wallet provider system, e.g. MasterPass or ApplePay.

The payment facilitation system 18 may be embodied by a computer system 600 as particularly shown in FIG. 6. In some embodiments, the payment facilitation system 18 may comprise multiple servers in communication with each other, for example over a local area network or a wide-area network such as the Internet. As described in the preceding section, the payment facilitation system 18 is able to communicate with other components of the payment facilitation network 10 over the network 20 using standard communication protocols.

The components of the payment facilitation system 18 can be configured in a variety of ways. The components can be implemented entirely by software to be executed on standard computer server hardware, which may comprise one hardware unit or different computer hardware units distributed over various locations, some of which may require the network 20 for communication. A number of the components or parts thereof may also be implemented by application specific integrated circuits (ASICs) or field programmable gate arrays.

In the example shown in FIG. 6, the payment facilitation system 18 is a commercially available server computer system based on a 32 bit or a 64 bit Intel architecture, and the processes and/or methods executed or performed by the payment facilitation system 18 are implemented in the form of programming instructions of one or more software components or modules 622 stored on non-volatile (e.g., hard disk) computer-readable data storage 624 associated with the payment facilitation system 18. As particularly shown in FIGS. 1, 1a, 3 and 4, the processes 100, 300 and 400 may be executed, at least in part, by the payment facilitation network 10 are implemented as programming instructions of one or more software modules 622 stored on non-volatile (e.g. hard disk or solid-state drive) storage. However, it will be apparent that at least parts of the aforementioned processes could alternatively be implemented as one or more dedicated hardware components, such as application-specific integrated circuits (ASICs) and/or field programmable gate arrays (FPGAs).

The payment facilitation system 18 comprises at least one or more of the following standard, commercially available, computer components, all interconnected by a bus 635:
(a) random access memory (RAM) 626;
(b) at least one computer processor 628, and
(c) external computer interfaces 630:
   (i) universal serial bus (USB) interfaces 630a (at least one of which is connected to one or more user-interface devices, such as a keyboard, a pointing device (e.g., a mouse 632 or touchpad),
   (ii) a network interface connector (NIC) 630b which connects the computer system 600 to a data communications network, such as the network 20; and
   (iii) a display adapter 630c, which is connected to a display device 634 such as a liquid-crystal display (LCD) panel device.

The payment facilitation system 18 comprises a plurality of standard software modules, including:
(a) an operating system (OS) 636 (e.g., Linux or Microsoft Windows);
(b) web server 638 (e.g., Apache, available at http://www.apache.org);
(c) scripting language modules 640 (e.g., personal home page or PHP, available at http://www.php.net, or Microsoft ASP); and
(d) structured query language (SQL) modules 642 (e.g., MySQL, available from http://www.mysql.com), which allow data to be stored in and retrieved/accessed from an SQL database 616.

Advantageously, the database 616 forms part of the computer readable data storage 624. Alternatively, the database 616 is located remote from the computer system 600 shown in FIG. 6.

Together, the web server 638, scripting language modules 640, and SQL modules 642 provide the payment facilitation system 18 with the general ability to allow the other components of the payment facilitation network 10 to communicate with the payment facilitation system 18 and in particular to provide data to and receive data from the database 616. It will be understood by those skilled in the art that the specific functionality provided by the payment facilitation system 18 to such users is provided by scripts accessible by the web server 638, including the one or more software modules 622 implementing the processes performed by the payment facilitation system 18, and also any other scripts and supporting data 644, including mark-up language (e.g., HTML, XML) scripts, PHP (or ASP), and/or CGI scripts, image files, style sheets, and the like.

Communication module 182 is in communication with NIC 630b which allows computer system 600 to communicate with entities such as the mobile computing device 12, merchant's terminal 16, social media system 14 and authorization system 22.

The merchant identification module 184 is in communication with database 616. For example, in step 105, step 112 is performed by the merchant identification module and a merchant's terminal 16 is identified using check-in data received from the social media system 14. The merchant identification module 184 may include a look up function to identify the merchant and retrieve data associated with the merchant's terminal 16.

The payment processing module 186 may be provided for by being in communication with the authorization system 22. Alternatively, the authorization system 22 forms part of the payment facilitation system 18.

The determining module 188 is provided for by RAM 626 and allows the payment facilitation system 18 to perform processes to determine invoice amounts, for example.

The boundaries between the modules and components in the software modules 622 are examples only, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the processes of the payment facilitation system 18 may be executed by a module (of software modules 622) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The payment facilitation system 18 normally processes information according to a program (a list of internally stored instructions such as a particular application program and/or an operating system) and produces resultant output information via external computer interfaces 630 or input/output (I/O) devices. A computer process typically comprises an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

### Authorization System 22

The authorization system 22 is able to communicate with the payment facilitation system 18 through standard communication protocols provided for by network 20, in order to receive requests for payment authorization, process such requests, and convey responses back to the payment facilitation system 18. In some embodiments, the authorization system 22 is part of the payment facilitation system 18.

For example, the authorization system 22 may comprise an acquirer system (which may in turn comprise a core banking system in communication with an acquirer processor system), a payment network (such as Mastercard, Visa or China Unionpay) and an issuer system (which may comprise a core banking system and an issuer processor system). Advantageously, the authorization system 22 further comprises a digital wallet provider system.

The authorization system 22 may receive the payment authorization request via the acquirer system, which routes the request via the payment network to the issuer system in a manner known in the art. The request may be formatted according to the ISO 8583 standard, for example, and may comprise a primary account number (PAN) of the payment instrument being used for the transaction, a merchant identifier (MID), and an amount of the transaction, as well as other transaction-related information as will be known by those skilled in the art. The issuer system receives the request, applies authorization logic to approve or decline the request, and sends an authorization response (approve or decline, optionally with a code indicating the reason for the decline) back to the acquirer system via the payment network in known fashion. The acquirer system then communicates the authorization response to the payment facilitation system 18.

Alternatively, in some embodiments, the authorization system 22 may receive the payment authorization request via the issuer system, which approves or declines the request (which again may be in ISO 8583 format, and comprise a PAN, MID, transaction amount etc.) and sends a response directly back to the payment facilitation system 18.

In addition to processing requests for payment in which funds are actually transferred from the cardholder's account (maintained in the issuer's core banking system) to the merchant's account (maintained in the acquirer's core banking system), the authorization system 22 may process a pre-authorization (or “pre-auth”) request, in which funds are not transferred on approval of the request, but are instead placed on hold. The pre-auth can later be completed, for example by the merchant's point of sales system or the payment facilitation system 18, in order to release the funds. Alternatively, the pre-auth can be cancelled, thus effectively cancelling the transaction.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge.

1. A payment facilitation system for facilitating payment for a transaction, the system comprising one or more processors in communication with non-transitory data storage medium having instructions stored thereon which, when executed by the processor or processors, configure the system to perform the steps of:
(a) receiving a check-in notification from a social media system, the notification including:
(i) customer identification data for one or more customers; and
(ii) merchant identification data;
(b) identifying a merchant terminal, the merchant terminal being a merchant terminal of a merchant associated with the merchant identification data;
(c) sending an enabled payment notification to the merchant terminal, the enabled payment notification comprising a group identifier associated with the one or more customers;
(d) receiving an invoice notification from the merchant terminal, the invoice notification comprising:
(i) transaction data for the transaction; and
(ii) the group identifier;
(e) sending the transaction data to one or more customer devices, each customer device being associated with a respective one of the one or more customers, based on the customer identification data;
(f) receiving confirmation to process the transaction, from one of the one or more customer devices; and
(g) processing the transaction in response to receiving the confirmation to process the transaction.

2. The payment facilitation system claimed in claim 1, wherein the transaction data further comprises one or more of the following:
(i) a total amount associated with an invoice;
(ii) an itemized list of items purchased by the transaction; and
(iii) an amount associated with each item in the itemized list.

3. The payment facilitation system claimed in claim 2, wherein the transaction data is stored in the non-transitory storage medium and comprises the total amount and, after the step of processing the transaction, the system performs the steps of:
(h) retrieving, from the non-transitory data storage medium, the total amount associated with the invoice;
(i) retrieving, from the non-transitory data storage medium, an amount associated with the processed transaction;
(j) determining if the amount associated with the processed transaction is at least equal to the total amount associated with the invoice;
(k) responsive to a determination that the amount associated with the transaction is less than the total amount to be paid;
(i) determining a remainder amount associated with the invoice by deducting the amount associated with the processed transaction from the total amount associated with the invoice;
(ii) updating the transaction data to include the remainder amount and to reflect the processed transaction;
(iii) sending the updated transaction data to the one or more customer devices;
(iv) receiving confirmation to process the transaction, from at least one of the one or more customer devices; and
(v) processing the transaction in response to receiving the confirmation to process the transaction.

4. The payment facilitation system claimed in claim 3, further comprising repeating steps (h) to (k) until a total amount associated with the one or more processed transactions is at least equal to the total amount associated with the invoice.

5. The payment facilitation system claimed in claim 1, wherein the customer identification data includes one or more of the following:
(i) name of each customer;
(ii) image associated with each customer; and
(iii) a unique identifier that uniquely identifies each customer.

6. The payment facilitation system claimed in claim 1, wherein after the step of receiving a check-in notification, the system performs the steps of:
(i) identifying, from a list of merchants stored in the non-transitory data storage medium, the merchant based on the merchant identification data, to confirm the merchant is a registered merchant; and
(ii) responsive to a determination that the merchant is a registered merchant, performing steps (b) to (g).

7. The payment facilitation system claimed in claim 1, wherein the merchant terminal is one or more of the following:
(i) computing device;
(ii) mobile computing device; and
(iii) point-of-sales system.

8. The payment facilitation system claimed in claim 1, wherein the merchant identification data is one or more of the following:
(i) name of merchant;
(ii) location of merchant; and
(iii) a unique identifier that uniquely identifies the merchant.

9. The payment facilitation system claimed in claim 1, wherein the group identifier is a unique number uniquely identifying a group comprising the one or more customers.

10. A payment facilitation method for facilitating payment for a transaction, performed by one or more processors in communication with non-transitory data storage medium having instructions stored thereon which, when executed by the processor or processors, performs the steps of:
(a) receiving a check-in notification from a social media system, the notification including:
(i) customer identification data for one or more customers; and
(ii) merchant identification data;
(b) identifying a merchant terminal, the merchant terminal being a merchant terminal of a merchant associated with the merchant identification data;
(c) sending an enabled payment notification to the merchant terminal, the enabled payment notification comprising a group identifier associated with the one or more customers;
(d) receiving an invoice notification from the merchant terminal, the invoice notification comprising:
(i) transaction data for the transaction; and
(ii) the group identifier;
(e) sending the transaction data to one or more customer devices, each customer device being associated with a respective one of the one or more customers, based on the customer identification data;
(f) receiving confirmation to process the transaction, from one of the one or more customer devices; and
(g) processing the transaction in response to receiving the confirmation to process the transaction.

11. The payment facilitation method claimed in claim 10, wherein the transaction data further comprises one or more of the following:
(i) a total amount associated with an invoice;
(ii) an itemized list of items purchased by the transaction; and
(iii) an amount associated with each item in the itemized list.

12. The payment facilitation method claimed in claim 11, wherein the transaction data is stored in the non-transitory storage medium and comprises the total amount and, after the step of processing the transaction, the method further comprising:
(h) retrieving, from the non-transitory data storage medium, the total amount associated with the invoice;
(i) retrieving, from the non-transitory data storage medium, an amount associated with the processed transaction;
(j) determining if the amount associated with the processed transaction is at least equal to the total amount associated with the invoice;
(k) responsive to a determination that the amount associated with the transaction is less than the total amount to be paid;
(i) determining a remainder amount associated with the invoice by deducting the amount associated with the processed transaction from the total amount associated with the invoice;
(ii) updating the transaction data to include the remainder amount and to reflect the processed transaction;
(iii) sending the updated transaction data to the one or more customer devices;
(iv) receiving confirmation to process the transaction, from at least one of the one or more customer devices; and
(v) in response to receiving the confirmation to process the transaction, processing the transaction.

13. The payment facilitation method claimed in claim 12, further comprising repeating steps (h) to (k) until a total amount associated with the one or more processed transactions is at least equal to the total amount associated with the invoice.

14. The payment facilitation method claimed in claim 10, wherein the customer identification data includes one or more of the following:
(i) name of each customer;
(ii) image associated with each customer; and
(iii) a unique identifier that uniquely identifies each customer.

15. The payment facilitation method claimed in claim 10, wherein after the step of receiving a check-in notification, the method further comprising:
(i) identifying, from a list of merchants stored in the non-transitory data storage medium, the merchant based on the merchant identification data, to confirm the merchant is a registered merchant; and
(ii) responsive to a determination that the merchant is a registered merchant, performing steps (b) to (g).

16. The payment facilitation method claimed in claim 10, wherein the merchant terminal is one or more of the following:
(i) computing device;
(ii) mobile computing device; and
(iii) point-of-sales system.

17. The payment facilitation method claimed in claim 10, wherein the merchant identification data is one or more of the following:
(i) name of merchant;
(ii) location of merchant; and
(iii) a unique identifier that uniquely identifies the merchant.

18. The payment facilitation method claimed in claim 10, wherein the group identifier is a unique number uniquely identifying a group comprising the one or more customers.

19. The payment facilitation method claimed in claim 12, wherein after the step of receiving a check-in notification, the method further comprising:
(i) identifying, from a list of merchants stored in the non-transitory data storage medium, the merchant based on the merchant identification data, to confirm the merchant is a registered merchant; and
(ii) responsive to a determination that the merchant is a registered merchant, performing steps (b) to (g).

20. A payment facilitation network for facilitating payment for a transaction, the payment facilitation network comprising:
a payment facilitation system;
a social media system;
a merchant terminal; and
one or more customer devices,
the payment facilitation system, social media system, merchant terminal and one or more customer devices communicating to perform the steps of:
(i) receiving, at the payment facilitation system, a check-in notification sent from the social media system, the notification including:
(A) customer identification data for one or more customers; and
(B) merchant identification data;
(ii) identifying, at the payment facilitation system, the merchant terminal, the merchant terminal being a merchant terminal of a merchant associated with the merchant identification data;
(iii) sending an enabled payment notification, from the payment facilitation system to the merchant terminal, the enabled payment notification comprising a group identifier associated with the one or more customers;
(iv) receiving, at the payment facilitation system, an invoice notification sent from the merchant terminal, the invoice notification comprising:
(A) transaction data for the transaction; and
(B) the group identifier;
(v) sending the transaction data, from the payment facilitation system to the one or more customer devices, each customer device being associated with a respective one of the one or more customers, based on the customer identification data;
(vi) receiving, at the payment facilitation system, confirmation to process the transaction, from one of the one or more customer devices; and
(vii) processing the transaction, at the payment facilitation system in response to receiving the confirmation to process the transaction.
